(19) United States
(12) Patent Application Publication
(10) Pub. No.: US 2026/0326304 A1
(43) Pub. Date: Oct. 22, 2026

(54) Method of Determining Relationship Between Robot Coordinate System and External Surface

(71) Applicant: ABB Schweiz AG, Baden (CH)

(72) Inventors: Henrik Knobel, Täby (SE); Roy Fraser, Lymm, Cheshire (GB)

(21) Appl. No.: 19/104,385

(22) PCT Filed: Aug. 23, 2022
(86) PCT No.: PCT/EP2022/073499

§ 371 Date: Feb. 18, 2025

(51) Int. Cl. B25J 9/16; B25J 13/00; B25J 13/08

(52) U.S. Cl. CPC B25J 9/1694; B25J 13/006; B25J 13/089

(57) ABSTRACT

A method of determining a relationship between a robot coordinate system of an industrial robot and an external surface at least partly reachable by the industrial robot, the method includes providing at least one tracking device, each tracking device being configured to independently determine its position and to provide position data indicative of the position; positioning one or more of the at least one tracking device on the external surface; providing, in a control system, position data from each tracking device while one or more of the at least one tracking device is positioned on the external surface; and determining, by the control system, a relationship between the robot coordinate system and the external surface based on the position data from each tracking device, where the position data is indicative of at least two different positions. A control system is also provided.

### TECHNICAL FIELD

The present disclosure generally relates to calibration of industrial robots. In particular, a method of determining a relationship between a robot coordinate system and an external surface, a control system for determining a relationship between a robot coordinate system and an external surface, and a robot system comprising an industrial robot, a tracking device and a control system, are provided.

### BACKGROUND

Calibrating an industrial robot to an external surface, such as a conveyor, can be a tedious and difficult operation, but is also very important. In a pick and place application for example, the picking accuracy, i.e. the positioning accuracy of the robot when picking objects from a moving conveyor, is completely dependent on that the relation between the position of the robot and the conveyor is well established.

The most common procedure used today for calibrating a robot to an external surface is to manually perform the calibration steps. To this end, the robot is jogged with a well-defined tool center point (TCP) to a plurality of defined reference positions with respect to the external surface. For each reference position, a pose (position and orientation) of the TCP is stored. Based on the stored TCP poses, a position and orientation of the external surface can be determined in a robot coordinate system of the robot. The robot is thereby calibrated to the external surface. This calibration process requires expert skills (e.g. knowledge and experience) and is time consuming. An accurate calibration result also requires manual skills to jog the TCP with high accuracy to the different reference positions that are recorded. Some parts of the external surface may also not be reachable by the robot.

US 2017066133 A1 discloses a method of setting a conveyor coordinate system having a predetermined relationship with a base coordinate system of a robot. A jig having two unique features is placed on a movable part of a conveyor. The robot carries a sensor that is able to detect a position of each of the plurality of features. The sensor may include a camera. The positions of the features are detected in two different operating positions of the movable part.

### SUMMARY

Although a camera can be used to determine positions of features on an external surface in order to calibrate an industrial robot to the external surface, this approach has several drawbacks. For example, in order to reliably determine a position of the features on the external surface, the relative position between the camera and the feature is quite limited. Each feature has to be positioned in the field of view of the camera and the camera may have to be positioned such that an optical axis of the camera intersects the feature. The camera also has to be calibrated and has to be kept in vicinity of the industrial robot for any future calibrations. The process of calibrating the industrial robot to the external surface using a camera is therefore expensive, time consuming, complicated and not possible in many situations.

One object of the invention is to provide an improved method of determining a relationship between a robot coordinate system and an external surface.

A further object of the invention is to provide an improved control system.

A still further object of the invention is to provide an improved robot system. These objects are achieved by the method, the control system,, and the robot system according to the claims.

The invention is based on the realization that by providing tracking devices capable of determining their own positions and by manually positioning these tracking devices on an external surface, a relationship between a robot coordinate system and the external surface can be determined in a versatile, less complicated, and more cost-efficient manner.

According to a first aspect, there is provided a method of determining a relationship between a robot coordinate system of an industrial robot and an external surface at least partly reachable by the industrial robot, the method comprising providing at least one tracking device, each tracking device being configured to independently determine its position and to provide position data indicative of the position; positioning one or more of the at least one tracking device on the external surface; providing, in a control system, position data from each tracking device while one or more of the at least one tracking device is positioned on the external surface; and determining, by the control system, a relationship between the robot coordinate system and the external surface based on the position data from each tracking device, where the position data is indicative of at least two different positions.

The one or more tracking devices can easily be manually placed on the external surface and can easily be manually moved between different external surfaces for different calibrations. A human user may for example grab and place the one or more tracking devices by hand. This principle is much simpler than removing and installing a camera for each calibration and is much cheaper than having a camera associated with each external surface, in particular if considering that a robot system may comprise a plurality of robots and a plurality of external surfaces. The method therefore has huge advantages in comparison with a calibration between a robot and an external surface using a camera, and also in comparison with a calibration between a robot and an external surface where a TCP is manually jogged to a plurality of reference positions. The cost efficiency of the method is even more noticeable when calibrating a relatively high number of robots, such as ten robots, to one or more external surfaces.

By virtue of the one or more tracking devices being configured to determine their positions on their own, the method enables accurate calibration of the robot and the external surface without being dependent on manual skills. The method can for example be carried out as long as a user can position one or more tracking devices at any position on the external surface. The method does, for example, not require that the one or more tracking devices are within reach of, or within a field of view from, any camera carried by the robot.

When the relationship between the robot coordinate system and the external surface is determined, the robot and the external surface are calibrated. The determination of the relationship between the robot coordinate system and the external surface may comprise determining a position and orientation of the external surface in the robot coordinate system. Once the one or more tracking devices have been manually placed on the external surface, the method can be performed automatically.

The external surface may be a work surface for the robot. For example, the robot may be configured to pick an object from the external surface and/or to place an object on the external surface. The external surface may or may not be flat. An external surface of a circular conveyor may for example be conical. The external surface is external with respect to the robot.

Each tracking device may be configured to determine a relative position or an absolute position. A relative position can be determined based on displacements of the tracking device relative to an unknown reference position. Each tracking device can determine its absolute position if the tracking device is calibrated to a known reference position. The known reference position may be at a known position in the robot coordinate system.

Each tracking device may comprise one or more accelerometers. In this case, each tracking device may be configured to independently determine its position in relation to a reference position based on readings from the one or more accelerometers. In case the reference position is known, each tracking device can determine its absolute position. However, the method can also be carried out even if each tracking device only determines its position relative to an arbitrary common unknown position. Alternatively, or in addition, each tracking device may comprise a gyroscope.

Based on position data from a single tracking device in two different positions, a movement direction of the tracking device can be determined. Each tracking device and/or the control system may be configured to assign a time value to each position data. In this way, a speed of the tracking device can also be determined.

Each tracking device has a unique identity. Each tracking device may have a mass of 500 g or less. Each tracking device may for example be a tag, a puck or a chip.

The method may be carried out for a stationary external surface, such as a work surface on a stationary table. In case each tracking device is configured to determine its absolute position, the position and orientation of the stationary external surface can be determined based on position data from at least three tracking devices positioned on the stationary external surface. The method may thus be carried out without moving the robot. One or more tracking devices may be positioned at edges or corners of the stationary external surface. In this way, the boundaries of the stationary external surface can be gathered and informed to the robot.

In case each tracking device is only configured to determine its relative position, one tracking device may be positioned on the robot and three or more tracking devices may be positioned on the stationary external surface. The tracking device positioned on the robot may be configured to be moved by the robot to different known positions in the robot coordinate system. The tracking device may for example be positioned at the TCP or directly at a mounting interface of the robot. The position and orientation of the stationary external surface can be determined based position data from the tracking device positioned on the robot in at least two different positions and based on position data from the at least three tracking devices positioned on the stationary external surface.

The method may be carried out for a movable external surface, such as a linearly moving work surface on linear conveyor or a rotatable work surface on a rotatable conveyor. In case each tracking device is configured to determine its absolute position, a movement direction of the movable external surface (both linear and rotatable) can be determined based on position data from only a single tracking device positioned on the movable external surface in two different positions of the movable external surface. By positioning two or more tracking devices on the movable external surface, also the orientation of the movable external surface can be determined based on position data from these tracking devices in two different positions of the movable external surface. In case each tracking device is only configured to determine its relative position, the above examples may be modified by positioning one tracking device on the robot and also moving the robot.

The method enables a calibration of the robot and the external surface to be completed in minutes. The method therefore has great impact on integration and commissioning of robot systems.

Each tracking device may be configured to wirelessly transmit the position data to the control system. The wireless transmission may for example use Bluetooth® or RFID (radio-frequency identification).

Each tracking device may be configured to wirelessly transmit identification data indicative of an identity of the tracking device to the control system. This facilitates guiding a user in positioning a plurality of tracking devices, e.g. using a digital interface. In other words, the user can be instructed to position a particular tracking device at a particular position.

Each tracking device may perform telemetry to repeatedly collect position data, and optional identification data, and to transmit this data to the control system. Each tracking device may also be configured to independently determine its orientation. In this case, each tracking device may be configured to wirelessly transmit orientation data indicative of the orientation of the tracking device.

The method may further comprise setting, in the control system, an origin of an external coordinate system associated with the external surface at a position of one tracking device positioned on the external surface. For example, the user may place one of the tracking devices at the origin of the external coordinate system and one or more further tracking devices may be placed randomly on the external surface. This gives the user the opportunity to easily and intuitively decide where on the external surface the external coordinate system should be positioned.

The method may further comprise positioning one tracking device in a known position in the robot coordinate system; and providing, in the control system, position data from each tracking device while at least one tracking device is positioned on the external surface and one tracking device is positioned in the known position in the robot coordinate system.

One tracking device may be positioned on the industrial robot.

The method may further comprise providing, in the control system, position data from at least one tracking device while the industrial robot and the external surface are positioned in a first positional relationship; moving the industrial robot and/or the external surface such that the industrial robot and the external surface become positioned in a second positional relationship, different from the first positional relationship; and providing, in the control system, position data from at least one tracking device while the industrial robot and the external surface are positioned in the second positional relationship; wherein the relationship between the robot coordinate system and the external surface is determined based on position data from each of the first positional relationship and the second positional relationship.

The robot and/or the external surface may or may not stop at the second positional relationship. If the tracking devices provide position data synchronized in time, the robot and/or the external surface do not have to stop at the second positional relationship. Position data may be provided in this way from a plurality of additional positional relationships, e.g. a third, fourth and fifth positional relationship. For each tracking device that is in the same position in each of the first positional relationship and the second positional relationship, position data may only be provided for one of the first positional relationship and the second positional relationship.

According to a second aspect, there is provided a control system for determining a relationship between a robot coordinate system of an industrial robot and an external surface at least partly reachable by the industrial robot, the control system comprising at least one data processing device and at least one memory having at least one computer program stored thereon, the at least one computer program comprising program code which, when executed by the at least one data processing device, causes the at least one data processing device to provide position data from each of at least one tracking device while one or more of the at least one tracking device is positioned on the external surface, where the position data is indicative of a position of the respective tracking device; and determine a relationship between the robot coordinate system and the external surface based on the position data from each tracking device, where the position data is indicative of at least two different positions.

The at least one computer program may comprise program code which, when executed by the at least one data processing device, causes the at least one data processing device to perform, or command performance of, any step according to the present disclosure. The control system may for example be implemented in a robot controller, a computer, a programming device such as a teach pendant unit, and/or in a mobile phone.

The at least one computer program may comprise program code which, when executed by the at least one data processing device, causes the at least one data processing device to set an origin of an external coordinate system associated with the external surface at a position of one tracking device positioned on the external surface.

The at least one computer program may comprise program code which, when executed by the at least one data processing device, causes the at least one data processing device to provide position data from each tracking device while at least one tracking device is positioned on the external surface and one tracking device is positioned in a known position in the robot coordinate system.

The at least one computer program may comprise program code which, when executed by the at least one data processing device, causes the at least one data processing device to provide position data from one or more of the at least one tracking device while the industrial robot and the external surface are positioned in a first positional relationship; command the industrial robot and/or the external surface to move such that the industrial robot and the external surface become positioned in a second positional relationship, different from the first positional relationship; and provide position data from one or more of the at least one tracking device while the industrial robot and the external surface are positioned in the second positional relationship; wherein the relationship between the robot coordinate system and the external surface is determined based on position data from each of the first positional relationship and the second positional relationship.

According to a third aspect, there is provided a robot system comprising the control system according to the second aspect, the industrial robot and the at least one tracking device. The industrial robot, the at least one tracking device and the control system may be of any type according to the first and second aspects.

Each tracking device may be configured to wirelessly transmit the position data to the control system. Alternatively, or in addition, each tracking device may be configured to wirelessly transmit identification data indicative of an identity of the tracking device to the control system.

### BRIEF DESCRIPTION OF THE DRAWINGS

Further details, advantages and aspects of the present disclosure will become apparent from the following description taken in conjunction with the drawings, wherein:

FIG. 1: schematically represents a robot system comprising an industrial robot, a plurality of tracking devices and a stationary external surface;

FIG. 2: schematically represents a perspective view of one of the tracking devices;

FIG. 3: schematically represents a top view of the tracking device in FIG. 2 positioned in a reference structure;

FIG. 4: schematically represents the robot system and a plurality of tracking devices positioned on the external surface;

FIG. 5: schematically represents the robot system and a first positional relationship between the industrial robot and the external surface;

FIG. 6: schematically represents the robot system and a second positional relationship between the industrial robot and the external surface;

FIG. 7: schematically represents a further example of a robot system when comprising a linearly movable external surface and with a first positional relationship between the industrial robot and the external surface;

FIG. 8: schematically represents the robot system in FIG. 7 and a second positional relationship between the industrial robot and the external surface;

FIG. 9: schematically represents a further example of a robot system when comprising a rotatable external surface and with a first positional relationship between the industrial robot and the external surface; and

FIG. 10: schematically represents the robot system in FIG. 9 and a second positional relationship between the industrial robot and the external surface.

### DETAILED DESCRIPTION

In the following, a method of determining a relationship between a robot coordinate system and an external surface, a control system for determining a relationship between a robot coordinate system and an external surface, and a robot system comprising an industrial robot, a tracking device and a control system, will be described. The same or similar reference numerals will be used to denote the same or similar structural features.

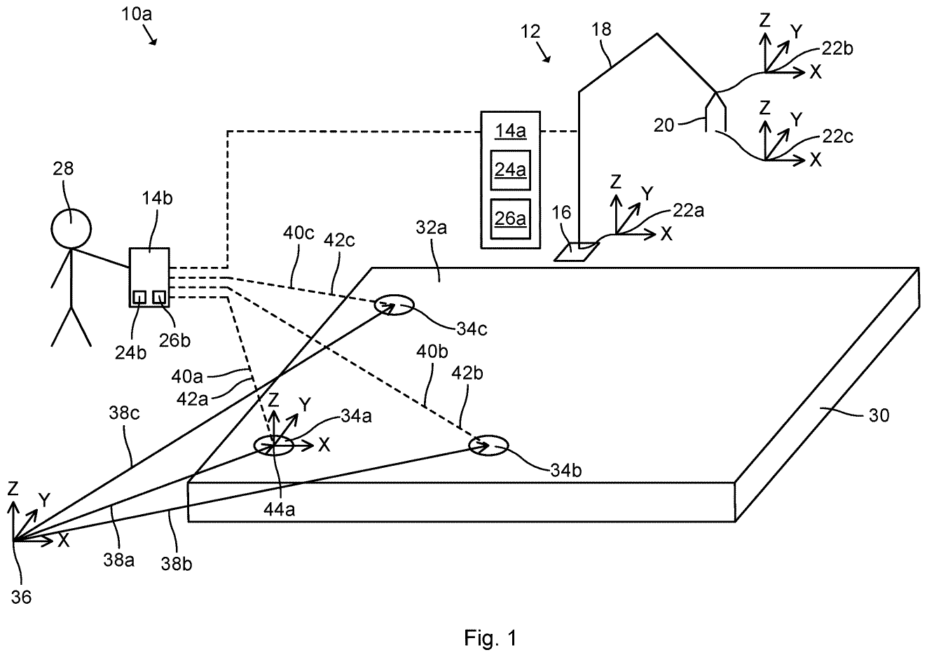

FIG. 1 schematically represents a robot system 10a. The robot system 10a comprises an industrial robot 12 and a robot controller 14a.

The industrial robot 12 of this example comprises a base 16, a manipulator 18 movable relative to the base 16, and an end effector 20 at a distal end of the manipulator 18. The end effector 20 is here exemplified as a gripper. The manipulator 18 may be movable in three or more axes, such as in six or seven axes.

The industrial robot 12 of this example comprises a base coordinate system 22a fixed to the base 16, a mounting interface coordinate system 22b fixed to a mounting interface at a distal end of the manipulator 18, and a tool coordinate system 22c at a fixed distance from the mounting interface coordinate system 22b. The base coordinate system 22a, the mounting interface coordinate system 22b and the tool coordinate system 22c each constitutes an example of a robot coordinate system according to the present disclosure. One, several or all of the robot coordinate systems 22a-22c may also be referred to with reference numeral “22”.

The robot controller 14a comprises a data processing device 24a and a memory 26a. The memory 26a has a computer program stored thereon. The computer program comprises program code which, when executed by the data processing device 24a, causes the data processing device 24a to perform, or command performance of, various steps described herein. In this example, the robot controller 14a is configured to control operations of the industrial robot 12. The robot controller 14a is one example of a control system according to the present disclosure.

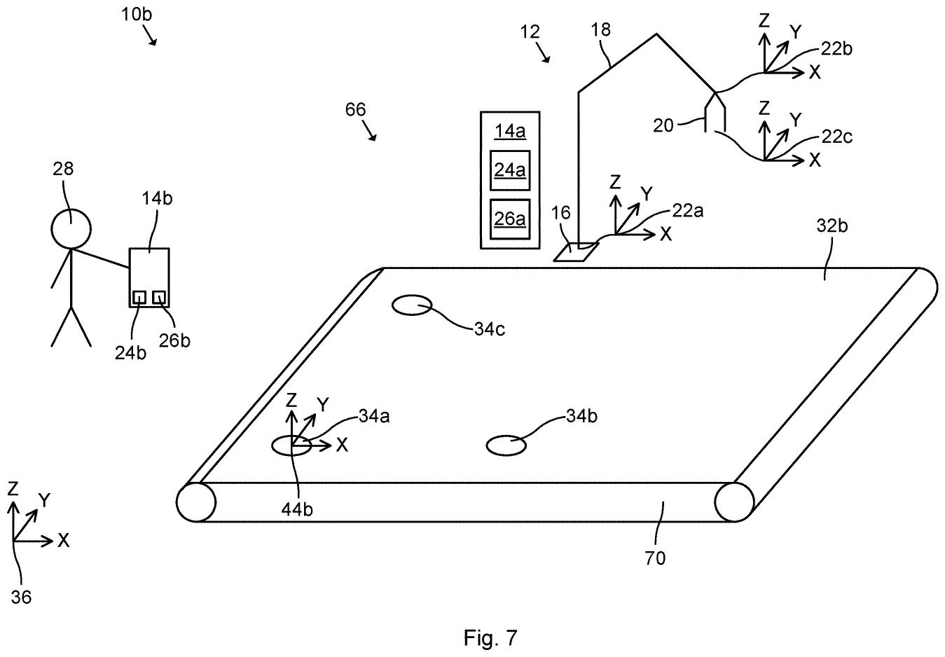

The robot system 10a of this example further comprises a mobile phone 14b. In FIG. 7, the mobile phone 14b is held by a human user 28. The mobile phone 14b comprises a data processing device 24b and a memory 26b. The memory 26b has a computer program stored thereon. The computer program comprises program code which, when executed by the data processing device 24b, causes the data processing device 24b to perform, or command performance of, various steps described herein. The mobile phone 14b is in signal communication with the robot controller 14a. In this example, the mobile phone 14b is configured to perform a calibration and to send a calibration result to the robot controller 14a. The mobile phone 14b is a further example of a control system according to the present disclosure. The functions performed by the mobile phone 14b may however be performed by a control system other than a mobile phone.

The robot system 10a of this example further comprises a stationary table 30. The table 30 comprises a stationary external surface 32a. The industrial robot 12 may for example perform a task comprising picking an object from the external surface 32a and/or placing an object on the external surface 32a. The external surface 32a of this example is flat.

The robot system 10a further comprises a plurality of tracking devices, here a first tracking device 34a, a second tracking device 34b and a third tracking device 34c. Each tracking device 34a-34c is configured to independently determine its position. One, several or all of the tracking devices 34a-34c may also be referred to with reference numeral “34”.

FIG. 1 further shows a reference coordinate system 36. In FIG. 1, the tracking devices 34a-34c have been placed on the external surface 32a by the user 28. The first tracking device 34a is positioned at a first position 38a in the reference coordinate system 36 and is configured to wirelessly send first position data 40a indicative of the first position 38a to the mobile phone 14b.

The second tracking device 34b is positioned at a second position 38b in the reference coordinate system 36 and is configured to wirelessly send second position data 40b indicative of the second position 38b to the mobile phone 14b. The third tracking device 34c is positioned at a third position 38c in the reference coordinate system 36 and is configured to wirelessly send third position data 40c indicative of the third position 38c to the mobile phone 14b.

The first tracking device 34a is also configured to wirelessly send first identification data 42a indicative of an identity of the first tracking device 34a to the mobile phone 14b. The second tracking device 34b is also configured to wirelessly send second identification data 42b indicative of an identity of the second tracking device 34b to the mobile phone 14b. The third tracking device 34c is also configured to wirelessly send third identification data 42c indicative of an identity of the third tracking device 34c to the mobile phone 14b.

One, several or all of the positions 38a-38c may also be referred to with reference numeral “38”. One, several or all of the position data 40a-40c may also be referred to with reference numeral “40”. Once, several or all of the identification data 42a-42c may also be referred to with reference numeral “42”.

The relationship between the reference coordinate system 36 and the base coordinate system 22a may or may not be known. In case there is a known offset between the base coordinate system 22a and the reference coordinate system 36, the positions 38 in the reference coordinate system 36 can easily be determined also in the base coordinate system 22a.

The position data 40 from all tracking devices 34 is synchronized in time. To this end, each tracking device 34 may associate the position data 40 with time data. Alternatively, the mobile phone 14b may register a point in time when the respective position data 40 is received. The position data 40 may be three-dimensional in the reference coordinate system 36. The wireless communication between the tracking devices 34 and the mobile phone 14b may for example use Bluetooth® or RFID.

FIG. 1 further shows an external coordinate system 44a associated with the external surface 32a. In this example, the first position 38a of the first tracking device 34a coincides with an origin of the external coordinate system 44a. The external coordinate system 44a may be used when controlling the industrial robot 12 in relation to the external surface 32a. For example, positions of objects (not shown) placed on the external surface 32a that are to be handled by the industrial robot 12 may be expressed in the external coordinate system 44a. For this reason, the external coordinate system 44a may also be referred to as an object frame.

The tracking devices 34 can be positioned on the external surface 32a outside reach of the industrial robot 12. Moreover, the tracking devices 34 do not have to be positioned within a field of view of any camera carried by the industrial robot 12.

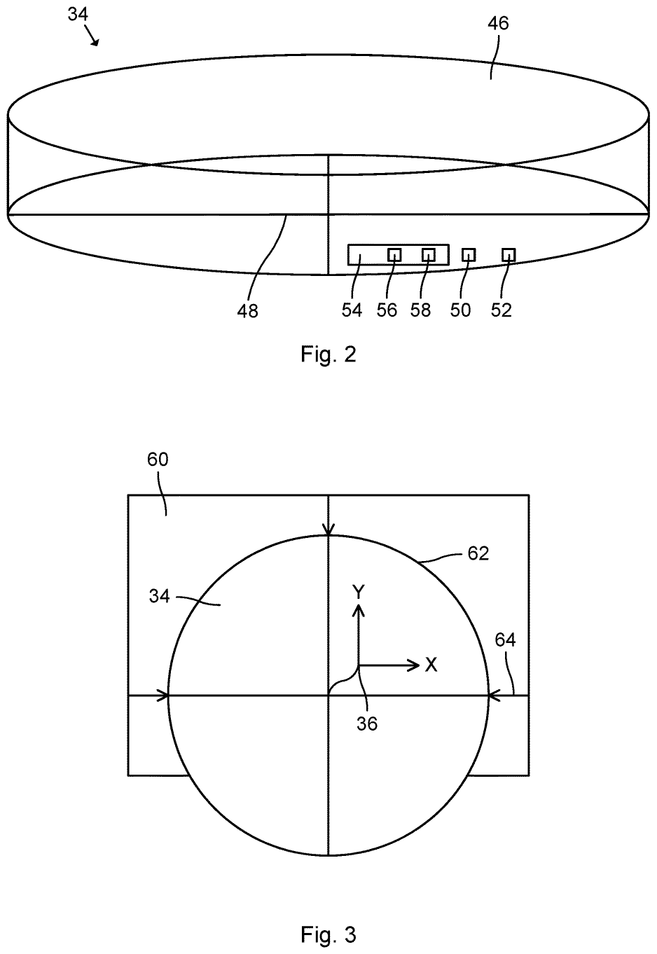

FIG. 2 schematically represents a perspective view of one of the tracking devices 34. Each tracking device 34 of the robot system 10a may be of the same type, such as the type in FIG. 2, and may differ only by the identification data 42.

The tracking device 34 comprises a body 46. In this example, the body 46 is transparent. The body 46 has a flat shape, here a cylindrical shape where a length of the cylinder is substantially shorter than a diameter of the cylinder.

The tracking device 34 comprises a crosshair 48. The crosshair 48 is centered at the position of the tracking device 34 as communicated by the tracking device 34. The crosshair 48 is visible for the user 28 through the body 46.

Due to the crosshair 48, the user 28 can precisely position the tracking device 34, if desired. The user 28 may for example want to position the tracking device 34 at an intended origin of the external coordinate system 44a or at one of the axes of the external coordinate system 44a.

The tracking device 34 of this specific and non-limiting example comprises a three-dimensional accelerometer 50, a transceiver 52 and a tracking controller 54. The tracking controller 54 comprises a data processing device 56 and a memory 58. The memory 58 has a computer program stored thereon. The computer program comprises program code which, when executed by the data processing device 56, causes the data processing device 56 to perform, or command performance of, various steps described herein. The tracking controller 54 is here configured to process data from the accelerometer 50 to provide position data 40 and to command the transceiver 52 to transmit the position data 40. The transceiver 52 is in signal communication with the mobile phone 14b.

FIG. 3 schematically represents a top view of the tracking device 34. The tracking device 34 is here positioned in a reference structure 60. The reference structure 60 of this specific and non-limiting example comprises a hole 62 and markings 64 such that the user 28 can position the tracking device 34 in an unequivocal position in relation to the reference structure 60 where the position 38 coincides with the origin of the reference coordinate system 36. When the tracking device 34 is positioned in this unequivocal position, the user 28 may reset the tracking device 34, for example by a button (not shown) on the tracking device 34 or by a command in the mobile phone 14b in communication with the transceiver 52. When the tracking device 34 has been reset in this way, the tracking device 34 is calibrated with respect to reference coordinate system 36. All tracking devices 34 may be calibrated in this way with respect to the same reference coordinate system 36. Alternative ways to calibrate the tracking device 34 are conceivable.

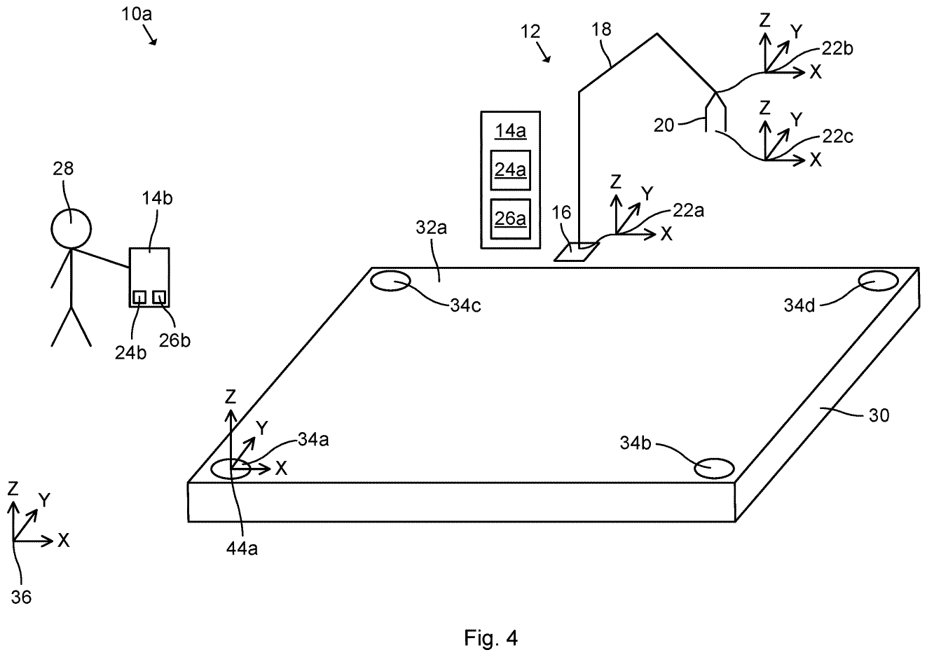

FIG. 4 schematically represents the robot system 10a where four tracking devices 34a-34d have been manually placed on the external surface 32a by the user 28. In FIG. 4, each tracking device 34 has been calibrated with respect to the reference coordinate system 36 and there is a known offset between the base coordinate system 22a and the reference coordinate system 36.

The tracking devices 34 can be put on the external surface 32a by the user 28 at a low effort. For example, both two tracking devices 34 and six tracking devices 34 can be put on the external surface 32a by the user 28 at low effort, but the calibration will be more accurate if using six tracking devices 34 than if using only two tracking devices 34.

Once the user 28 has positioned the tracking devices 34 on the external surface 32a, the user 28 may provide some preparatory information to the mobile phone 14b. Such preparatory information may comprise information that the external surface 32a is stationary, that the origin of the external coordinate system 44a should be positioned at the first position 38a of the first tracking device 34a, that the second position 38b of the second tracking device 34b should be position on the X-axis of the external coordinate system 44a, and that the third position 38c of the third tracking device 34c should be positioned on the Y-axis of the external coordinate system 44a.

The user 28 may then input a calibration command to the mobile phone 14b. In response to the calibration command, each tracking device 34 sends its position data 40 to the mobile phone 14b. Based on the position data 40, the mobile phone 14b can determine the position and the orientation of the external surface 32a in the base coordinate system 22a. The mobile phone 14b then wirelessly communicates the determined relationship between the base coordinate system 22a and the external surface 32a to the robot controller 14a.

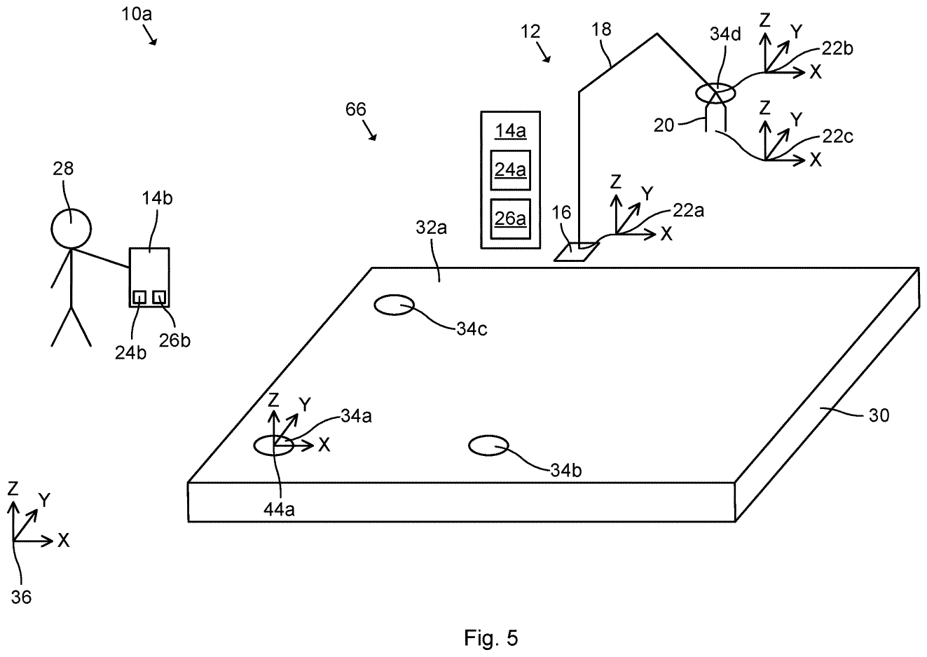

FIG. 5 schematically represents the robot system 10a where three tracking devices 34a-34c are positioned on the external surface 32a and the fourth tracking device 34d is fixed to the industrial robot 12, here at the mounting interface of the manipulator 18 such that the position of the fourth tracking device 34d coincides with the position of the mounting interface coordinate system 22b. In the example in FIG. 5, the position of the fourth tracking device 34d in the base coordinate system 22a is known. However, in contrast to the example in FIG. 4, the offset between the base coordinate system 22a and the reference coordinate system 36 is unknown in the example in FIG. 5.

One example of a situation when this offset is unknown may be when the base coordinate system 22a is initially associated with a second robot (not shown) and where a positional relationship between the industrial robot 12 and the second robot is unknown.

In FIG. 5, there is a first positional relationship 66 between the industrial robot 12 and the external surface 32a. In response to the calibration command, each tracking device 34 sends its position data 40 to the mobile phone 14b. Based on the position data 40, the mobile phone 14b can calculate distances between each pair of tracking devices 34. The mobile phone 14b then instructs the industrial robot 12 (here via the robot controller 14a) to move such that the fourth tracking device 34d becomes positioned differently in relation to the three tracking devices 34a-34c on the external surface 32a.

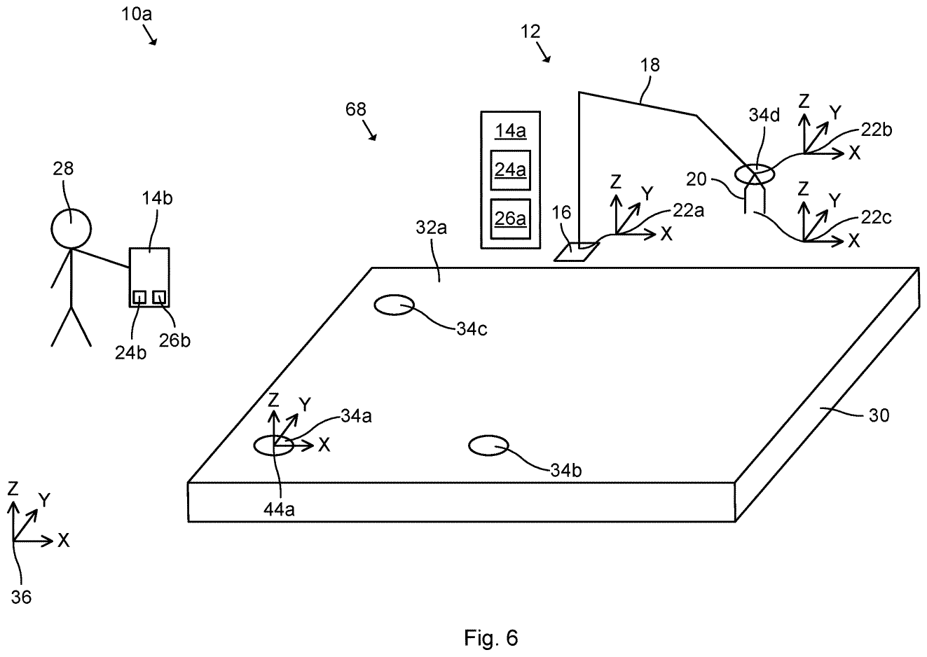

FIG. 6 schematically represents the robot system 10a and a second positional relationship 68 between the industrial robot 12 and the external surface 32a. In comparison with the first positional relationship 66, the industrial robot 12 has moved such that the fourth tracking device 34d is positioned differently in relation to the tracking devices 34a-34c on the external surface 32a in the second positional relationship 68. The industrial robot 12 may or may not be stopped in the second positional relationship 68.

Since the position of the fourth tracking device 34d in the base coordinate system 22a is known, and since all tracking devices 34 are calibrated to a common but unknown reference position, the positions of the fourth tracking device 34d and the distances between the tracking devices 34 in the first positional relationship 66 and in the second positional relationship 68 can be used to unambiguously determine a position and an orientation of the external surface 32a in the base coordinate system 22a. Also in this way, the robot coordinate system can be calibrated to the external surface 32a. The method can thus also be carried out without necessarily knowing the offset between the base coordinate system 22a and the reference coordinate system 36. This facilitates calibration since the reference structure 60 can be positioned at positions with unknown offsets to the robot coordinate system 22a.

The accuracy of the calibration will increase, without manual effort, with an increased amount of position data 40. The amount of position data 40 can be increased by providing additional tracking devices 34 and/or by collecting position data 40 in additional positional relationships, i.e. at more sampling positions.

When the position data 40 with respect to the external surface 32a is overdetermined, i.e. when the position data 40 can be expressed in sets of equations in which there are more equations than unknowns, the position and orientation of the external surface 32a can be determined in the base coordinate system 22a, for example by using the method of least squares. The more the external surface 32a can be overdetermined based on the position data 40, the higher is the accuracy of the calibration.

FIG. 7 schematically represents a further example of a robot system 10b. Mainly differences with respect to the robot system 10a will be described. The robot system 10b comprises a linearly movable external surface 32b, here provided on a linear conveyor 70. The robot controller 14a is here configured to also control operations of the linear conveyor 70. In FIG. 7, the industrial robot 12 and the external surface 32b are in a first positional relationship 66. In FIG. 7, the positional relationship between the reference coordinate system 36 and the base coordinate system 22a is known. Thus, each tracking device 34 can determine its position in the base coordinate system 22a. Although the position and orientation of the external surface 32b can be determined in the base coordinate system 22a in the situation in FIG. 7, a movement direction of the external surface 32b is unknown.

In FIG. 7, the first tracking device 34a has been placed at a desired origin of an external coordinate system 44b of the external surface 32b. The second tracking device 34b and the third tracking device 34c can be positioned arbitrarily on the external surface 32b.

When the user 28 has placed the tracking devices 34 on the external surface 32b and initiated the calibration, the communications between the tracking devices 34 and the mobile phone 14b are activated and position data 40 from each tracking device 34 in the first positional relationship 66 is sent to the mobile phone 14b. The linear conveyor 70 is then commanded to move the external surface 32b such that the industrial robot 12 and the external surface 32b become positioned in a second positional relationship 68.

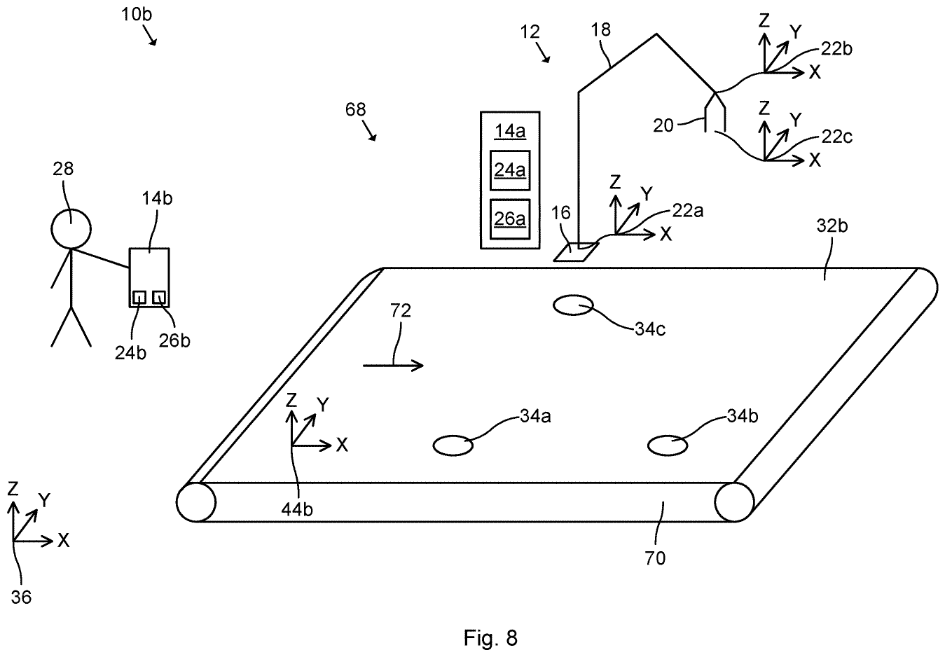

FIG. 8 schematically represents the robot system 10b and the second positional relationship 68 between the industrial robot 12 and the external surface 32b. Position data 40 from each tracking device 34 in the second positional relationship 68 is sent to the mobile phone 14b. The external surface 32b may or may not stop at the second positional relationship 68. As an alternative to a stop, the external surface 32b may move continuously while position data 40 from the tracking devices 34 and associated time data are repeatedly collected at each sampling time. Each stop or sampling time may constitute a unique positional relationship.

Based on the position data 40 from each tracking device 34 in each of the first positional relationship 66 and the second positional relationship 68, the mobile phone 14b can determine the position and the orientation of the external surface 32b and also a linear movement direction 72 of the external surface 32b in the base coordinate system 22a. The calibration according to this example can be carried out without moving the industrial robot 12 and optionally without stopping the linear conveyor 70.

Due to the first tracking device 34a and the third tracking device 34c being separated in a direction transverse to the linear movement direction 72, also a rotational position of the external surface 32b, e.g. about the X-axis of the reference coordinate system 36, can be unambiguously determined. The first tracking device 34a and the third tracking device 34c can also be used to determine a width of the external surface 32b. That is, it can be concluded that a width of the external surface 32b is at least as large as a distance along the Y-axis of the external coordinate system 44b between the first tracking device 34a and the third tracking device 34c. For this reason, the first and third tracking devices 34a and 34c may be positioned by the user 28 to span the width of the external surface 32b. Knowledge of the width of the external surface 32b enables a more efficient utilization of the linear conveyor 70 by the industrial robot 12.

With only one tracking device 34 positioned on the external surface 32b, the linear movement direction 72, but not the orientation of the plane of the external surface 32b, can be determined. Thus, as one possible alternative, it can be assumed that the external surface 32b is horizontal. In this case, the calibration of the base coordinate system 22a and the external surface 32b can be performed with only a single tracking device 34 on the external surface 32b (and no tracking device 34 on the industrial robot 12).

Although only two positions of the external surface 32b are shown in FIGS. 7 and 8, corresponding to the first positional relationship 66 and the second positional relationship 68, the measurements may be carried out repeatedly during movement of the external surface 32b. The more measurements that are collected, the higher the accuracy of the calibration will be.

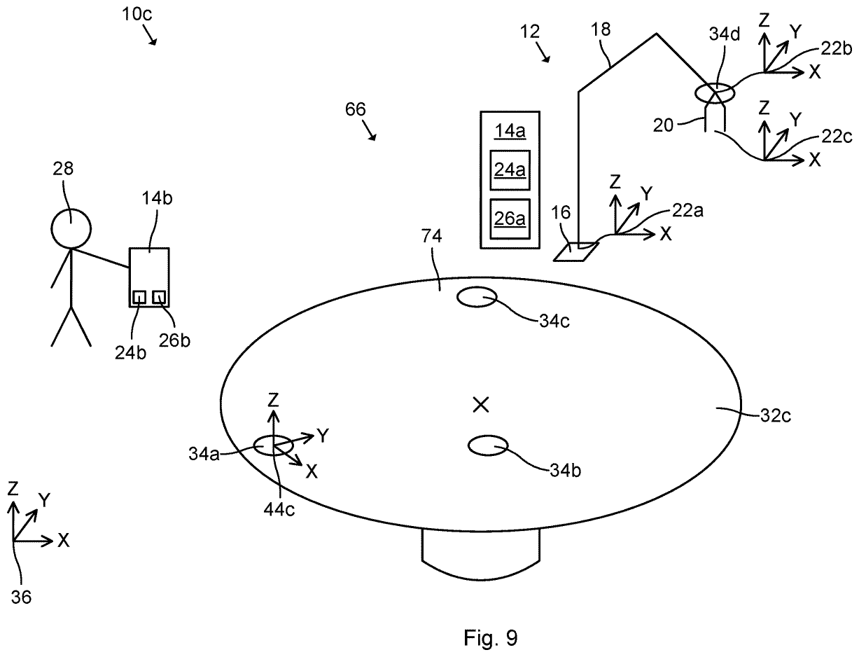

FIG. 9 schematically represents a further example of a robot system 10c. One, several or all of the robot systems 10a-10c may alternatively be referred to with reference numeral “10”. Mainly differences with respect to the robot systems 10a and 10b will be described. The robot system 10c comprises a rotatable external surface 32c, here provided on a circular conveyor 74. The robot controller 14a is here configured to also control operations of the circular conveyor 74. In FIG. 9, the industrial robot 12 and the external surface 32c are in a first positional relationship 66. Moreover, the positional relationship between the reference coordinate system 36 and the base coordinate system 22a is unknown.

In FIG. 9, the first tracking device 34a has been placed at a desired origin of an external coordinate system 44c of the external surface 32c. One, several or all of the external coordinate systems 44a-44c may also be referred to with reference numeral “44”. The second tracking device 34b and the third tracking device 34c have been positioned arbitrarily on the external surface 32b. The fourth tracking device 34d has been positioned on the industrial robot 12 at the origin of the mounting interface coordinate system 22b.

When the user 28 has placed the tracking devices 34 on the external surface 32c and initiated the calibration, the communications between the tracking devices 34 and the mobile phone 14b are activated and position data 40 from each tracking device 34 in the first positional relationship 66 is sent to the mobile phone 14b. The circular conveyor 74 is then commanded to move the external surface 32b such that the industrial robot 12 and the external surface 32b become positioned in a second positional relationship 68.

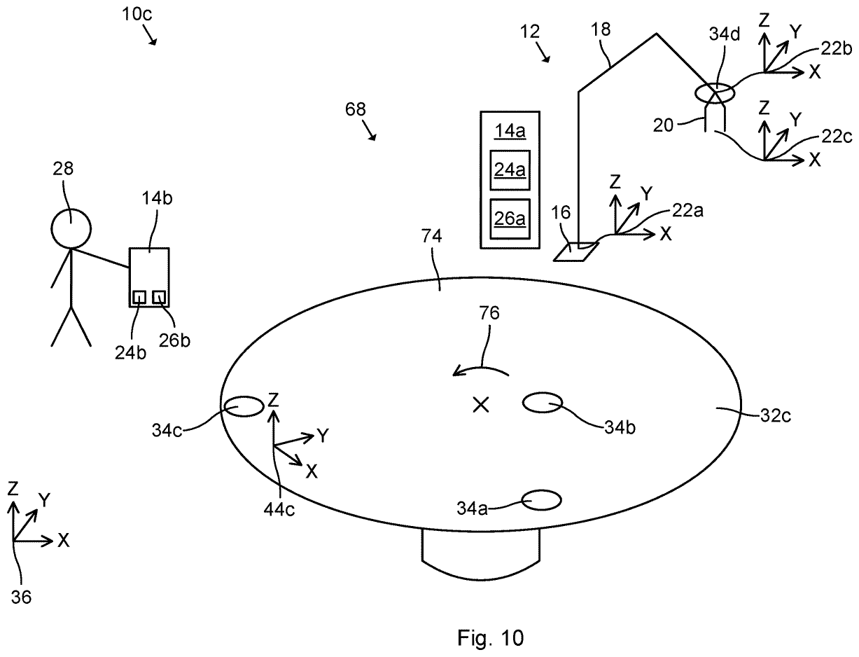

FIG. 10 schematically represents the robot system 10c and the second positional relationship 68 between the industrial robot 12 and the external surface 32c. Note that the pose of the industrial robot 12 is in this example the same in the first positional relationship 66 and in the second positional relationship 68. Position data 40 from each tracking device 34 in the second positional relationship 68 is sent to the mobile phone 14b. The external surface 32c may or may not stop at the second positional relationship 68.

Based on the position data 40 from each tracking device 34, the mobile phone 14b can determine distances between each pair of tracking devices 34 in each of the first positional relationship 66 and the second positional relationship 68. Based on these distances and based on the knowledge of the position of the fourth tracking device 34d in the base coordinate system 22a, the mobile phone 14b can determine the position and the orientation of the external surface 32c and also a circular movement direction 76 of the external surface 32c in the base coordinate system 22a.

Due to the first tracking device 34a and the second tracking device 34b being separated in a radial direction with respect to the circular movement direction 76, also a shape of the external surface 32c can be determined. For example, it can be determined whether the external surface 32c is flat or cone shaped. With only one tracking device 34 positioned on the external surface 32c, the circular movement direction 76, but not the shape of the external surface 32c, can be determined. Thus, as one possible alternative, it can be assumed that the external surface 32c is flat. In this case, the calibration of the base coordinate system 22a and the external surface 32c can be performed with only a single tracking device 34 on the external surface 32c.

Although only two positions of the external surface 32b are shown in FIGS. 9 and 10, corresponding to the first positional relationship 66 and the second positional relationship 68, the measurements may be carried out repeatedly during movement of the external surface 32c. The more measurements that are collected, the higher the accuracy of the calibration will be.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A method of determining a relationship between a robot coordinate system of an industrial robot and an external surface at least partly reachable by the industrial robot, the method comprising:
providing at least one tracking device, each tracking device being configured to independently determine its position and to provide position data indicative of the position;
positioning one or more of the at least one tracking device on the external surface;
providing, in a control system position data from each tracking device while one or more of the at least one tracking device is positioned on the external surface; and
determining, by the control system, a relationship between the robot coordinate system and the external surface based on the position data from each tracking device, where the position data is indicative of at least two different positions.

2. The method according to claim 1, wherein each tracking device is configured to wirelessly transmit the position data to the control system.

3. The method according to claim 2, wherein each tracking device is configured to wirelessly transmit identification data, indicative of an identity of the tracking device to the control system.

4. The method according to claim 1, further comprising setting, in the control system, an origin of an external coordinate system associated with the external surface at a position of one tracking device positioned on the external surface.

5. The method according to claim 1, further comprising:
positioning one tracking device outside the external surface in a known position in the robot coordinate system; and
providing, in the control system, position data from each tracking device while at least one tracking device is positioned on the external surface and one tracking device is positioned outside the external surface in the known position in the robot coordinate system.

6. The method according to claim 5, wherein one tracking device is positioned on the industrial robot.

7. The method according to claim 1, further comprising:
providing, in the control system, position data from at least one tracking device while the industrial robot and the external surface are positioned in a first positional relationship;
moving the industrial robot and/or the external surface such that the industrial robot and the external surface become positioned in a second positional relationship, different from the first positional relationship; and
providing, in the control system, position data from at least one tracking device while the industrial robot and the external surface are positioned in the second positional relationship;
wherein the relationship between the robot coordinate system and the external surface is determined based on position data from each of the first positional relationship and the second positional relationship.

8. A control system for determining a relationship between a robot coordinate system of an industrial robot and an external surface at least partly reachable by the industrial robot, the control system comprising at least one data processing device and at least one memory having at least one computer program stored thereon, the at least one computer program including a program code which, when executed by the at least one data processing device, causes the at least one data processing device to:
provide position data from each of at least one tracking device while one or more of the at least one tracking device is positioned on the external surface, where the position data is indicative of a position of the respective tracking device; and
determine a relationship between the robot coordinate system and the external surface based on the position data from each tracking device, where the position data is indicative of at least two different positions.

9. The control system according to claim 8, wherein the at least one computer program comprises program code which, when executed by the at least one data processing device, causes the at least one data processing device to:
set an origin of an external coordinate system associated with the external surface at a position of one tracking device positioned on the external surface.

10. The control system according to claim 8, wherein the at least one computer program comprises program code which, when executed by the at least one data processing device, causes the at least one data processing device to:
provide position data from each tracking device while at least one tracking device is positioned on the external surface and one tracking device is positioned in a known position in the robot coordinate system.

11. The control system according to claim 8, wherein the at least one computer program comprises program code which, when executed by the at least one data processing device, causes the at least one data processing device to:
provide position data from at least one tracking device while the industrial robot and the external surface are positioned in a first positional relationship;
command the industrial robot and/or the external surface to move such that the industrial robot and the external surface become positioned in a second positional relationship, different from the first positional relationship; and
provide position data from at least one tracking device while the industrial robot and the external surface are positioned in the second positional relationship;
wherein the relationship between the robot coordinate system and the external surface is determined based on position data from each of the first positional relationship and the second positional relationship.

12. A robot system comprising a control system for determining a relationship between a robot coordinate system of an industrial robot and an external surface at least partly reachable by the industrial robot, the control system including at least one data processing device and at least one memory having at least one computer program stored thereon, the at least one computer program including a code which, when executed by the at least one data processing device, causes the at least one data processing device to:
provide position data from each of at least one tracking device while one or more of the at least one tracking device is positioned on the external surface, where the position data is indicative of a position of the respective tracking device; and
determine a relationship between the robot coordinate system and the external surface based on the position data from each tracking device, where the position data is indicative of at least two different positions:
an industrial robot; and
at least one tracking device.

13. The robot system according to claim 12, wherein each tracking device is configured to wirelessly transmit the position data to the control system.

14. The robot system according to claim 13, wherein each tracking device is configured to wirelessly transmit identification data indicative of an identity of the tracking device to the control system.

15. The method according to claim 2, further comprising setting, in the control system, an origin of an external coordinate system associated with the external surface at a position of one tracking device positioned on the external surface.

16. The method according to claim 2, further comprising:
positioning one tracking device outside the external surface in a known position in the robot coordinate system; and
providing, in the control system, position data from each tracking device while at least one tracking device is positioned on the external surface and one tracking device is positioned outside the external surface in the known position in the robot coordinate system.

17. The method according to claim 2, further comprising:
providing, in the control system, position data from at least one tracking device while the industrial robot and the external surface are positioned in a first positional relationship;
moving the industrial robot and/or the external surface such that the industrial robot and the external surface become positioned in a second positional relationship, different from the first positional relationship; and
providing, in the control system, position data from at least one tracking device while the industrial robot and the external surface are positioned in the second positional relationship;
wherein the relationship between the robot coordinate system and the external surface is determined based on position data from each of the first positional relationship and the second positional relationship.

18. The control system according to claim 9, wherein the at least one computer program comprises program code which, when executed by the at least one data processing device, causes the at least one data processing device to:
provide position data from each tracking device while at least one tracking device is positioned on the external surface and one tracking device is positioned in a known position in the robot coordinate system.

19. The control system according to claim 9, wherein the at least one computer program comprises program code which, when executed by the at least one data processing device, causes the at least one data processing device to:
provide position data from at least one tracking device while the industrial robot and the external surface are positioned in a first positional relationship;
command the industrial robot and/or the external surface to move such that the industrial robot and the external surface become positioned in a second positional relationship, different from the first positional relationship; and
provide position data from at least one tracking device while the industrial robot and the external surface are positioned in the second positional relationship;
wherein the relationship between the robot coordinate system and the external surface is determined based on position data from each of the first positional relationship and the second positional relationship.
